(19) United States
(12) Patent Application Publication
(10) Pub. No.: US 2019/0270090 A1
(43) Pub. Date: Sep. 5, 2019

(54) SEPARATOR APPARATUS AND METHOD

(71) Applicant: Richard Henry Coulton, Earlswood (GB)

(72) Inventor: Richard Henry Coulton, Earlswood (GB)

(21) Appl. No.: 16/349,240

(22) PCT Filed: Nov. 8, 2017
(86) PCT No.: PCT/GB2017/053365

§ 371 Date: May 10, 2019

(30) Foreign Application Priority Data
Nov. 10, 2016 (GB) 1618995.3

(51) Int. Cl. B03B 5/62; B03B 11/00

(52) U.S. Cl. CPC B03B 5/623; B03B 2011/008; B03B 2011/006; B03B 11/00

(57) ABSTRACT

A separator for separating sand from organic matter comprises a first compartment (11) for receiving and separating a mixture of sand, organic matter and liquid, a plurality of liquid inlets (29) in a bottom region of the first compartment (11) for introducing liquid into the bottom region of the first compartment and generating an upward liquid flow in the first compartment, means (47) for removing organic matter from the top of the mixture in the first compartment (11), an outlet in an upper region of the first compartment (11) for the discharge of organic matter and liquid, and an outlet (9) in a lower region of the first compartment for the discharge of sand and liquid.

### CROSS-REFERENCE TO RELATED APPLICATIONS

This application claims priority to International Patent Application No. PCT/GB2017/053365 filed on Nov. 8, 2017, which claims priority to GB Patent Application No. 1618995.3 filed on Nov. 10, 2016, the contents of both of which are hereby incorporated herein in their entirety.

### FIELD OF THE INVENTION

The present invention concerns an apparatus and method for separating sand from organic matter. More particularly, but not exclusively, the invention concerns an apparatus and method for separating sand from cow slurry.

### BACKGROUND OF THE INVENTION

It is known that sand can provide a good bedding for cows and that it is preferable that some or all of the sand is relatively fine. Using such a bedding material then results over time in the generation of a mixture of sand and cow slurry which can be removed and replaced with a fresh sand bedding. It is then necessary to deal with the used mixture of sand and cow slurry. It is preferable to try to separate the sand from the mixture so that it can be re-used, but that is not straightforward. A known technique employs a settlement tank in which the generally higher settlement speed of sand particles compared to particles of organic matter is used to separate out the sand. A problem with this technique, however, is that fine sand particles settle more slowly than large particles of organic matter and it is therefore not possible to achieve good separation of the fine sand particles. Consequently, a significant amount of sand is separated with the organic matter and therefore lost. In the context of sewage installations, that problem has been addressed by providing a fluidised sand bed, as shown in U.S. Pat. No. 5,641,397. An apparatus of this kind may be suitable for use in the controlled environment of a sewage works and by a skilled operator but is not appropriate for use in other environments, for example on a farm where the mixture of sand and cow slurry is of highly variable nature and may well require pretreatment, where equipment needs to be simple to operate and where it is desirable to avoid transferring materials from one plant to another.

The present invention seeks to mitigate the above mentioned problems.

### SUMMARY OF THE INVENTION

The present invention provides, according to a first aspect, a separator for separating sand from organic matter, the separator comprising:

a first compartment for receiving and separating a mixture of sand, organic matter and liquid,

a plurality of liquid inlets in a bottom region of the first compartment for introducing liquid into the bottom region of the first compartment and generating an upward liquid flow in the first compartment, means for removing organic matter from the top of the mixture in the first compartment, an outlet in an upper region of the first compartment for the discharge of organic matter and liquid, and an outlet in a lower region of the first compartment for the discharge of sand and liquid.

In use of the separator, the upward flow of liquid may create a fluidised bed of sand. Whilst sand particles of all sizes may settle within that fluidised bed, particles of organic matter may float on top of the fluidised bed and can therefore then be separated from the sand. Sand is removed from the compartment, either continually or at intervals and may then be made available for reuse. Consequently very little sand need be lost in the separation process.

The liquid inlets in the bottom region may not be at the absolute bottom of the compartment; they may, for example, be at a level such that more than four fifths of the volume of the first compartment is disposed above the inlets. Another possibility is for the liquid to be introduced through openings in a floor of the compartment.

The liquid inlets may be in the form of plain apertures or may be nozzles. A one-way valve may be associated with each liquid inlet to prevent sand in the first compartment from entering the inlets.

The floor of the compartment may be a false floor within a tank, a bottom region of the tank being beneath the floor.

The outlet for sand and water may be provided in the bottom or the side, preferably a lower region of the side, of the first compartment.

Whilst reference is made above to a “first” compartment, it should be understood that in the broadest aspect of the invention the first compartment may be the only compartment. It is, however, especially preferred that the compartment is a first compartment within a tank that comprises the first compartment and a second compartment from which the mixture is arranged to be fed into the first compartment. The tank may comprise further compartments, including but not limited to a compartment below a false floor defining the bottom of the first compartment, but in an embodiment of the invention described below the tank comprises only two compartments. It would be possible and natural to provide the second compartment in which the initial treatment is carried out in a separate unit but by providing them both in the same physical unit the apparatus can be simplified, made more compact and be easier to operate. The single unit is preferably portable; for example it may be the shape and size of a standard 20 ft or 40 ft freight container and may have standard corner fittings, or it may be designed to be carried on a flat bed trailer. The first compartment is preferably bigger than the second compartment. In the case of a cuboidal tank, the first compartment may be separated from the second compartment by a partition that extends across the entire width of the tank, perpendicular to the adjoining walls of the tank.

The mixture may be arranged to be fed from the second compartment into the first compartment above the level of the liquid inlets. In use, the mixture may be arranged to be fed from the second compartment into an upper region of the fluidised sand bed, formed in use in the first compartment or just above it. The mixture being fed into the first compartment from the second compartment may leave the second compartment in an upper region thereof; that need not be at the absolute top of the second compartment; it may, for example, be at a level such that more than four fifths of the volume of the second compartment is disposed below the level at which the mixture leaves the second compartment. The level at which the mixture leaves the second compartment may be defined by a weir. The weir may be provided on a weir plate joined to the partition between the first and second compartments. The weir plate may extend upwardly from the partition; the upper end of the weir plate may define the weir. An opening in the partition above the junction of the weir plate and the partition may define the inlet through which the mixture is fed into the first compartment from the second compartment.

A mixer may be provided in the second compartment. The mixer may serve to keep sand in the mixture in suspension, and/or to break down the organic/sand mixture either purely by mixing or partly or wholly by the addition of a dilution liquid. A liquid inlet may be provided in the second compartment; that may facilitate the dilution step just referred to. The mixer may comprise a blade mixer; blades of the mixer may be disposed in a lower region of the second compartment. The blades of the mixer may be mounted on one or more vertical shafts and may, in use, be rotated by a motor mounted at the top of the second compartment. By providing such a second compartment upstream of the first compartment, the versatility of the separator is much improved since dilution and/or agitation of the incoming mixture of sand and organic matter can be carried out in the second compartment.

The liquid inlets may be spread across substantially all of the bottom region of the first compartment. Liquid introduced, in use, through the inlets preferably flows upwardly across substantially the whole of the compartment; in that way the sand can be fluidised across the whole compartment. An array of parallel pipes, each pipe having a plurality of openings along its length, may extend across the bottom region of the first compartment and define the liquid inlets. The parallel pipes may be connected to a common liquid inlet manifold. In a case where the inlets are in a floor of the compartment they may be spread evenly across the floor, for example in a square, triangular or hexagonal pattern.

The means for removing organic matter from the top of the mixture in the first compartment may comprise one or more paddles mounted for movement across an upper region of the first compartment. The paddles may be arranged to be driven along their paths of movement continuously. The paddles may be in the form of scraper blades. The paddles may be mounted for movement around an endless path. The path may be generally in the shape of an elongate oval, the paddles being arranged to extend into the organic matter during their travel along a lower side of the oval. The blades may be driven by a motor via a chain and sprocket drive. Each of said one or more paddles may extend across the upper region of the first compartment from one side to the other and may be mounted for movement along the first compartment in a direction transverse to the direction in which the paddles extends. The paddles may alternatively be mounted on a shaft for rotation about a fixed axis which may be horizontal; in such a case the axis of rotation may extend across the compartment; there may be one or more sets of such paddles.

In an embodiment of the invention described below with reference to the drawings, all the liquid that is discharged from an upper region of the first compartment is discharged through the same outlet as the organic matter. If desired, a further liquid outlet for discharging liquid only may be provided.

Removal of sand from the first compartment may be regulated automatically. The rate at which the sand is removed may be controlled by one or more pressure gauges located in the first compartment, for example on a side wall. As the sand bed level rises pressure at a level below the top of the bed increases and conversely reducing as the pressure and hence the bed level decreases. Thus the pressure sensed by the one or more pressure gauges may be arranged to control the rate of removal of sand. The rate control may be a switching on and off of sand removal or it may be a variation in the rate of sand removal. By this means the position of the top of the sand bed can be held constant or maintained within a narrow operating band.

One or more valves, for example, pinch valves, may be provided in a bottom region, which may be the bottom, of the first compartment for defining sand and liquid outlets. The opening and closing of the one or more pinch valves may be controlled by the pressures sensed by the one or more pressure gauges.

An auger may be provided with its inlet opening into the bottom region of the first compartment and defining the sand and liquid outlet in the lower region of the first compartment. The auger may be one or more screw augers. The rate of rotation of the auger, which may be a screw auger, may be controlled by the pressures sensed by the one or more pressure gauges. The auger may be arranged to convey sand from the bottom region of the first compartment to another region of the separator.

The separator may further comprise a means of separating sand from the sand and liquid mixture discharged from the first compartment. The separating means may comprise rotating screens, inclined screens, vibrating screens or other forms of separators for separating solid particles from liquid. The means for separating sand from the sand and liquid mixture may comprise a conveyor and the conveyor may be incorporated in the same physical unit as the first and second compartments. In this case further processing of the materials is carried out in a single physical unit, avoiding the need for certain ancillary apparatus. The means for separating sand from the sand and liquid mixture may comprise an auger. In the case that an auger is arranged to convey sand from the bottom region of the first compartment to another region of the separator, the same auger may also function to separate sand from the sand and liquid mixture.

At said another region a conveyor for feeding sand to a sand outlet of the separator may be provided. The conveyor may be a vibrating screen.

The downstream end of the conveyor for feeding sand may be at a level raised above the level of the bottom of the first compartment. Preferably the downstream end of the conveyor is at least 0.5 m above the bottom of the separator; that allows sand to be discharged from the separator into a container by gravity.

The conveyor may be arranged, in use, to vibrate for conveying the sand. While reference is made above to “an auger” and just one auger may be provided, more than one auger may also be provided. In an embodiment of the invention described below, a first auger is provided in a channel extending across the bottom of the first compartment for feeding sand to one side of the compartment and a second auger is provided for receiving sand from the first auger and conveying it to said another region. The second auger may be inclined. The second auger may be disposed along the exterior of the first compartment.

The separator may further comprise a support frame for supporting the first compartment above the level of the ground. By raising the first compartment, it becomes possible for a sand outlet even at the bottom of the first compartment to be disposed above ground level so that sand can be removed from the separator at least partly by gravity.

The support frame may define a walkway alongside an upper region of the first compartment. The support frame may further comprise a ladder for facilitating access to the walkway.

The separator may further comprise a means of separating organic matter from the organic matter and liquid mixture discharged from the first compartment.

The separating means may comprise rotating screens, inclined screens, vibrating screens or other forms of separators for separating solid particles from liquid. The means for separating organic matter from the organic matter and liquid mixture may comprise a conveyor screen and the conveyor screen may be incorporated in the same physical unit as the first and second compartments. In this case further processing of the materials is carried out in a single physical unit, avoiding the need for certain ancillary apparatus.

A conveyor for feeding organic matter to an outlet of the separator may be provided. The conveyor may be a vibrating screen.

The downstream end of the conveyor for feeding organic matter to the outlet may be at a level raised above the level of the bottom of the first compartment. Preferably the downstream end of the conveyor is at least 0.5 m above the bottom of the separator; that allows matter to be discharged from the separator into a container by gravity.

The conveyor may be arranged, in use, to vibrate for conveying the organic matter.

Liquid separated from the sand and/or organic matter may be recycled by means of a pump or pumps as grey water; that reduces the amount of water required for operation. If desired the grey water may be treated and/or diluted with clean water before being returned to the first compartment through the liquid inlets. The liquid may also be returned to the second compartment to dilute the incoming slurry and aid the separation of the sand from the organic matter.

The separator may further comprise a pump or other means of regulating the pressure and flow rate of liquid from other sources into the liquid inlets in the bottom region of the compartment and/or as a dilution liquid into the second compartment.

The present invention also provides, according to a second aspect, a method of separating sand from organic matter, the method comprising the following steps:

feeding a mixture of sand and organic matter into a first compartment;

introducing liquid into a bottom region of the first compartment to generate an upward flow of liquid and create a fluidised bed of sand in the first compartment;

removing organic matter and liquid from the top of the mixture in the first compartment; and

removing sand and liquid from a lower region of the first compartment.

The fluidised bed of sand may be created in a lower region only of the first compartment. That allows space above the fluidised bed for organic matter that floats on the fluidised bed. The level of the fluidised bed may be regulated by regulating the removal of sand from the first compartment.

Sand may be removed from the bottom of the first compartment by an auger arrangement.

The mixture of sand and organic matter may be fed into a second compartment and may pass from there into the first compartment. The mixture of sand and organic matter may further comprise liquid and/or liquid may be added to the mixture in the second compartment.

The mixture of sand, organic matter and liquid may be fed into the first compartment at a level below or just above the top of the fluidised bed.

The mixture of sand and organic matter in the second compartment may be agitated. That may maintain the sand in suspension and/or break up the organic matter.

Liquid may be introduced into the bottom region of the first compartment at a multiplicity of locations spread across the compartment.

Organic matter may be removed from the surface of the mixture in the first compartment, preferably by scraping.

Liquid removed from the first compartment may be introduced back into the bottom region of the first compartment.

The liquid may be grey water.

In an especially preferred method, the first and second compartments are provided in a single physical unit.

The organic matter may be cow manure or cow slurry and may be fed into the separator diluted with liquid such as grey water, if desired.

The sand may be sand suitable for use as bedding for cows and may include fine sand. During use of the sand as bedding material, the sand and cow manure/slurry become mixed. After a period of use it becomes desirable to replace the mixture with fresh sand. The apparatus and method of the present invention is able to take the mixture and separate the sand from the manure. A farmer can then make use of the manure for agricultural purposes and use the recovered sand as bedding material. It will therefore be understood that the “sand” and the “organic matter” referred to above may contain a modest amount of foreign bodies.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

An embodiment of the present invention will now be described by way of example with reference to the accompanying schematic drawings of which:

FIG. 1 is an isometric view of a separator for separating sand from organic matter in accordance with a first example embodiment of the invention;

FIG. 2 is a cut away isometric view of a tank of the separator of the first embodiment of FIG. 1;

FIG. 3 is a side view of a separator for separating sand from organic matter in accordance with a second example embodiment of the invention;

FIG. 4 is an isometric view from one direction of the separator of the second embodiment shown in FIG. 3; and

FIG. 5 is an isometric view from another direction of the separator of the second embodiment shown in FIG. 3.

### DETAILED DESCRIPTION

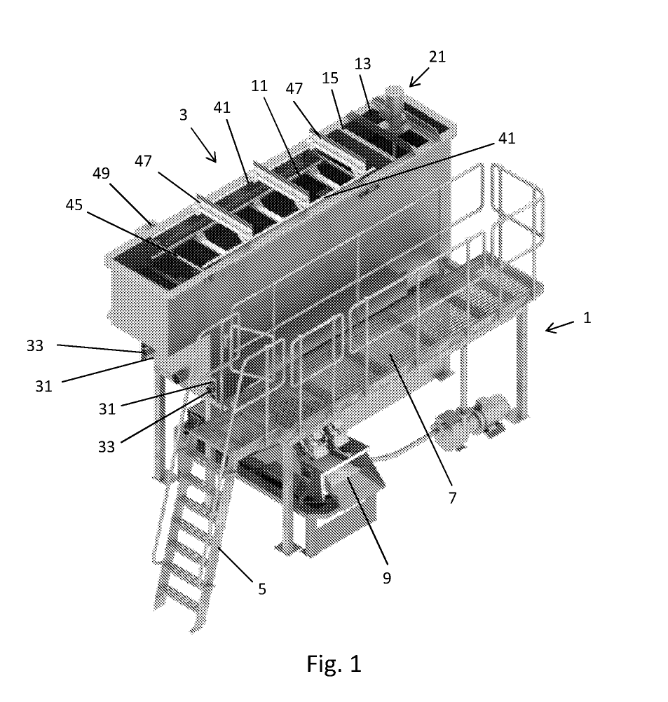

Referring first to FIG. 1, a separator generally comprises a framework 1 and a tank 3 supported in an elevated position. The framework incorporates a ladder 5 which provides access to a walkway 7 which is at a height that allows a user to see into the tank 3 which is open-topped. Beneath the tank 3 is a sand outlet 9 which can be opened to allow sand to fall out of the separator into a suitable transport device (not shown).

The separator is designed to be suitable for separating sand from organic matter and may be fed with sand that has been used as bedding material for cows and therefore contains cow manure. The separator seeks to separate the sand from the organic matter, allowing the sand to be re-used as bedding material. For that purpose, it is desirable that fine sand particles are separated out with other coarser sand because the fine particles improve the quality of the bedding material.

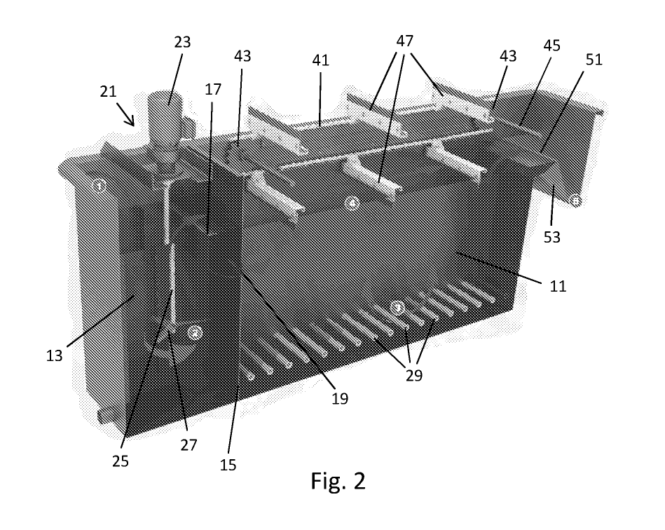

Referring now also to FIG. 2, the tank 3 is cuboidal and is divided into a larger first compartment 11 and a smaller second compartment 13 by a vertical partition 15 that extends across the tank 3 at a position about one third of the way along the tank.

A weir plate 17 is fixed to the partition 15 and extends upwardly from the partition. An inlet 19 into the first compartment 11 from the second compartment 13 is provided immediately above the junction of the weir plate 17 and the partition 15.

A mixer 21 is mounted across the top of the second compartment 13. The mixer 21 comprises a motor 23 which drives a vertical shaft 25 carrying mixer blades 27 which are disposed in a lower region of the second compartment 13.

In a bottom region of the first compartment 11 there are a multiplicity of pipes 29 which extend across the full width of the compartment and pass through the side walls of the compartment to provide fluid communication with manifolds 31 that extend along the exterior sides of the compartments 11 and 13 and that each have a port 33 at one end.

The pipes 29 are equispaced and extend horizontally across the first compartment 11, and each pipe 29 has a plurality of openings distributed along its length.

A scraper assembly is provided at the top of the first compartment 11, the assembly comprising, along each interior side, a chain and sprocket drive comprising a chain 41 and sprockets 43 at each end. The chain 41 follows the path of an elongate oval with each long side of the oval path horizontal, defining upper and lower runs of the chain. The sprockets 43 are fixed to axles 45 which extend across the compartment to connect each sprocket 43 on one side of the compartment to a corresponding sprocket on the opposite side (not visible in FIG. 2) so that the sprockets rotate in unison. Scraper blades 47 are fixed at intervals along the chains 41 and extend across the compartment 11 and outwardly from the chains 41 perpendicular to the paths of the chains. One of the sprockets is driven by a suitable drive (for example another chain and sprocket drive) mounted on the outside of the compartment 11, part of the housing 49 of the drive being visible in FIG. 1. The blades 47 are arranged to be driven in a direction away from the second compartment 13 during their operative lower run, with the blades 47 extending vertically downwardly from the chains 41.

At the end of the first compartment 11 opposite the partition 15 and at approximately the level of the bottoms of the scraper blades 47 during their lower run, an outlet 51 for organic matter is provided, the outlet leading to a hopper 53 in which the organic matter is collected.

Before first using the separator, sand is added to the first compartment 11 to a level just above the level of the inlet 19. During use, a mixture of sand and cow slurry is fed into the top of the second compartment 13. The mixture may be fed through a pipe or poured in from another vessel. It is important that the mixture in the second compartment is flowable and, if necessary, additional water may be added to achieve that. The mixer 21 is operated and maintains a uniform mix throughout the compartment 13. In particular the agitation is sufficient to prevent sand particles settling in the second compartment 13.

The level of the mixture in the second compartment 13 rises as the mixture is added to the second compartment and in due course reaches the level of the top of the weir plate 17. It then overflows and enters the first compartment 11 through the inlet 19.

Water is pumped into the pipes 29 through one or both of the manifolds 31 and rises upwards through the first compartment 11, fluidising the sand in that compartment. As a result, when the mixture of sand and organic matter enters the compartment through the inlet 19, the organic matter rises up onto the top of the fluidised bed of sand, while the sand is simply added to the fluidised bed. The organic matter on the top of the fluidised bed is scraped to the right, as seen in FIG. 2, by the scraper blades 47 which are driven by the chain and sprocket drive. The organic matter therefore leaves the first compartment 11 through the outlet 51 and collects in the hopper 53, from which it can be removed periodically through an opening in the bottom of the hopper.

As sand is added to the fluidised bed of sand its level rises. A pressure gauge (not shown) on a side wall of the first compartment 11 in a lower region thereof detects the rising of the pressure caused by the rising sand level and periodically, when the pressure exceeds a predetermined value, a valve in the passageway leading to the sand outlet 9 is opened to extract sand from the separator. The pressure then reduces and, at a predetermined reduced pressure, the valve in the sand outlet 9 is closed. In that way it is possible to regulate the level of the fluidised sand. The sand that is extracted contains substantially the same proportion of fine particles as the mixture fed into the separator and the extracted sand can then be re-used as a bedding material.

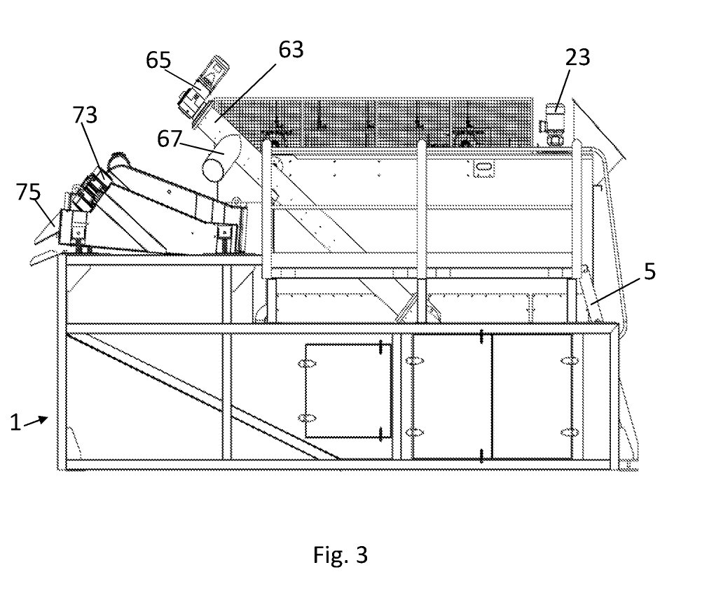

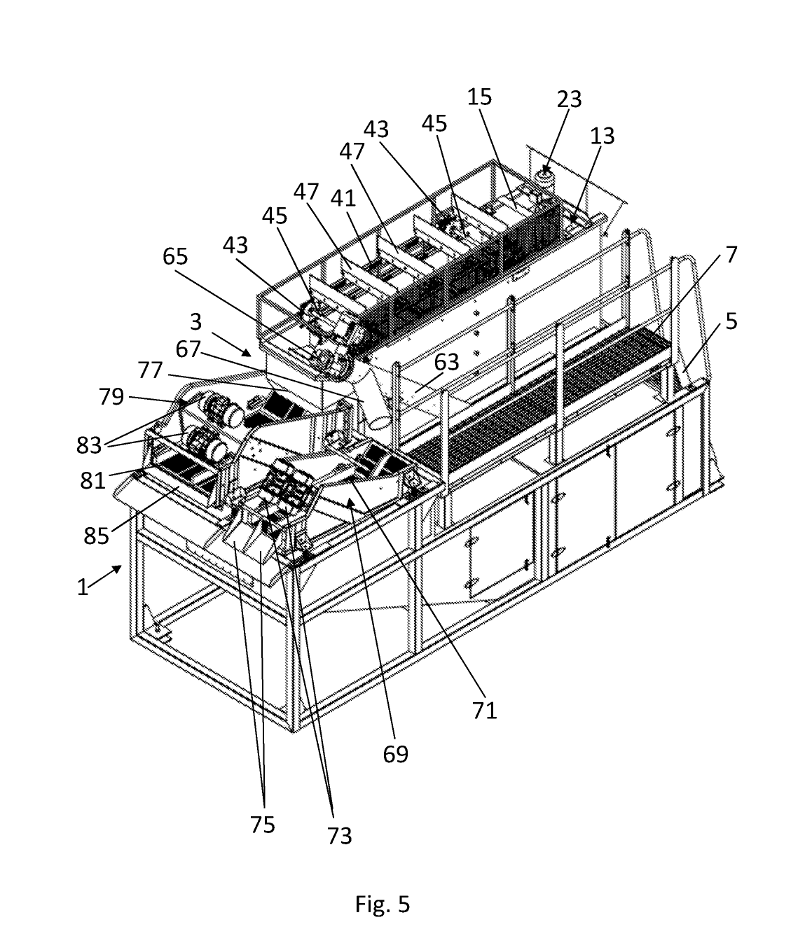

In a more sophisticated arrangement the sand outlet 9 may be connected directly to the inlet of an upwardly inclined screw auger whose speed of operation is controlled by the pressure gauge, thereby maintaining the level of sand in the compartment 11 at a substantially constant level. The second form of the separator described below with reference to FIGS. 3 to 5 is of this kind. As will be understood, an alternative arrangement would be to switch the auger on and off to control the level of sand within a range of levels.

The sand is discharged from the separator along with water and may be screened in a further screening apparatus (not shown) to remove the water. Similarly the mixture of water and organic matter discharged from the hopper 53 may be screened in another further screening apparatus (not shown) to remove the water. Water from each of the screening operations may be recycled, with or without further treatment, being introduced through the pipes 29 into the first compartment and/or being added to the mixture in the second compartment. In embodiments comprising a screw auger the length of the auger may be sufficient such that the water is removed from the sand by the time the sand reaches the distal end of the auger.

Referring now to FIGS. 3 to 5, there is shown a second form of separator which is similar to the first form of separator described above with reference to FIGS. 1 and 2. Parts shown in FIGS. 3 to 5 that correspond to and are substantially similar to parts shown in FIGS. 1 and 2 are referenced by the same reference numerals as are used in FIGS. 1 and 2. The description below of the second form of separator will focus on the parts that differ significantly from the first form of separator.

The main differences relate to the collection of the sand and the organic material from the separator.

As already indicated an auger arrangement is employed to control the removal of the sand.

Consequently, the sand outlet 9 of the first form of separator need not be provided. In the particular arrangement shown there are two screw augers: a first cross auger is provided in an open-topped channel in the bottom of the first compartment and extends across the compartment. A motor drive 61 is provided to rotate the cross auger for removing sand from the bottom of the compartment and feeding it to the bottom of a second inclined auger 63. A motor drive 65 is provided to rotate the inclined auger 63 for receiving sand delivered by the cross auger and raising it up the auger to an outlet pipe 67 whose open outlet end is above a sand receptacle 69. The sand receptacle 69 may take various forms including that of a simple hopper but in the embodiment shown in FIGS. 3 to 5 comprises a conveyor 71 which can be vibrated by a pair of vibrators 73 to feed sand to outlets 75, beneath which a suitable container (not shown) may be placed.

Organic material scraped away by the blades 47 falls through an outlet 77 into an organic material receptacle 79. The receptacle 79 may take various forms including that of a simple hopper but in the embodiment shown in FIGS. 3 to 5 comprises a conveyor 81 which can be vibrated by a pair of vibrators 83 to feed the organic material to an outlet 85, beneath which a suitable container (not shown) may be placed.

As will now be understood the second form of separator is operated in substantially the same way as the first form, differing principally in the way in which sand and organic material are collected after their separation. Those collection processes will now be described.

The speed of operation of the cross auger and the inclined auger 63 is controlled in order to keep the level of the fluidised bed of sand in the first compartment approximately constant. The augers feed sand from the bottom of the first compartment up into the outlet pipe 67 from where it falls into the sand receptacle 69. The sand collects there until, periodically and when required, the conveyor 71 is vibrated. When that occurs the sand in the receptacle 69 is fed to the outlets 75 from which it falls into a container placed on the ground below the outlets 75.

Organic material scraped away by the blades 47 falls through the outlet 77 into the receptacle 79. The organic material collects there until, periodically and when required, the conveyor 81 is vibrated. When that occurs the organic material in the receptacle 79 is fed to the outlet 85 from which it falls into a container placed on the ground below the outlet 85.

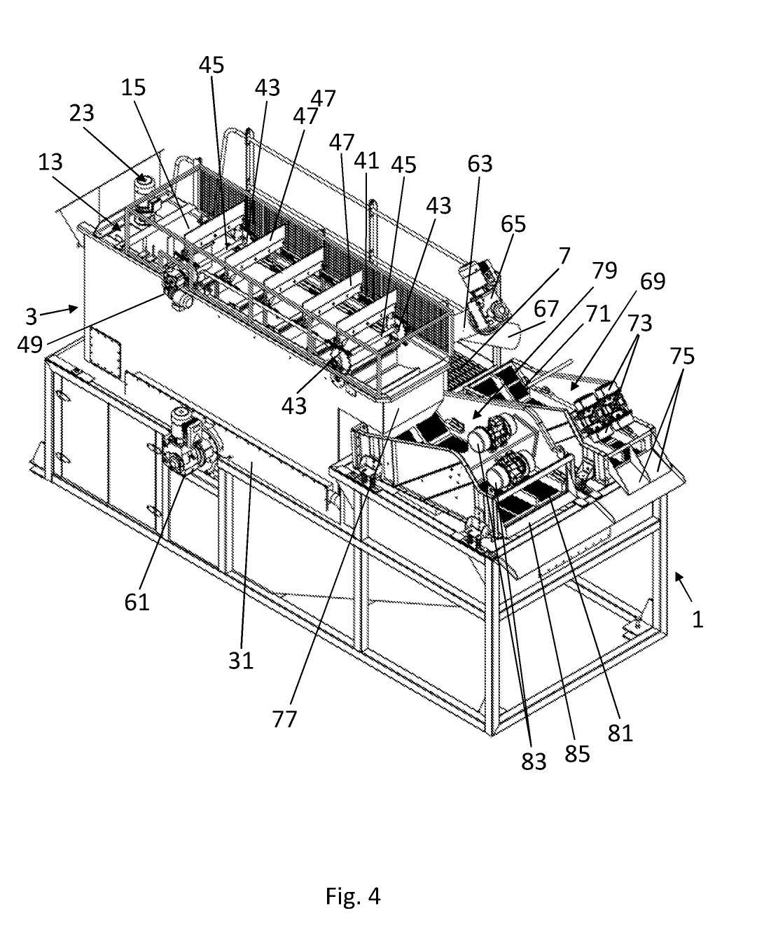

The conveyors 71 and 81 also receive water with the sand and organic material and that is allowed to pass through the conveyors and is returned to the manifold 31 (FIG. 4).

The second form of separator is especially advantageous in that it provides all necessary treatments within a single physical unit. Thus the processes of any initial dilution of the mixture of slurry and sand to be treated, agitation of the mixture, the separation of the sand and the organic materials, and the removal of water from the separated materials are all carried out in the single unit. That results in a particularly compact complete treatment system that is simple to manage and operate.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

### EXAMPLE EMBODIMENTS

Example 1 includes a separator for separating sand from organic matter, the separator comprising: a first compartment for receiving and separating a mixture of sand, organic matter and liquid, a plurality of liquid inlets in a bottom region of the first compartment for introducing liquid into the bottom region of the first compartment and generating an upward liquid flow in the first compartment, means for removing organic matter from the top of the mixture in the first compartment, an outlet in an upper region of the first compartment for the discharge of organic matter and liquid, and an outlet in a lower region of the first compartment for the discharge of sand and liquid.

Example 2 includes a separator according to example 1, in which the compartment is a first compartment within a tank that comprises the first compartment and a second compartment from which the mixture is arranged to be fed into the first compartment.

Example 3 includes a separator according to example 2, wherein the tank is cuboidal in shape and the first compartment is separated from the second compartment by a partition that extends across the entire width of the tank, perpendicular to the adjoining walls of the tank.

Example 4 includes a separator according to example 2 or 3, in which a mixer is provided in the second compartment.

Example 5 includes a separator according to any preceding example, in which the liquid inlets are spread across substantially all of the bottom region of the first compartment.

Example 6 includes a separator according to any preceding example, in which an array of parallel pipes, each pipe having a plurality of openings along its length, extend across the bottom region of the first compartment and define the liquid inlets.

Example 7 includes a separator according to any of examples 1 to 5, in which the liquid inlets are provided in the bottom of the first compartment.

Example 8 includes a separator according to example 7, in which the bottom of the first compartment comprises a false floor within a tank.

Example 9 includes a separator according to any preceding example, in which the means for removing organic matter from the top of the mixture in the first compartment comprises one or more paddles mounted for movement across an upper region of the first compartment.

Example 10 includes a separator according to example 9, in which said one or more paddles are mounted for movement around an endless path.

Example 11 includes a separator according to example 9 or 10, in which the paddles are in the form of scraper blades.

Example 12 includes a separator according to any of examples 9 to 11, in which each of said one or more paddles extends across the upper region of the first compartment from one side to the other and is mounted for movement along the first compartment in a direction transverse to the direction in which the paddle extends.

Example 13 includes a separator according to any of examples 9 to 11, in which the paddles are mounted on a shaft for rotation about a fixed axis.

Example 14 includes a separator according to any preceding example, in which removal of sand from the first compartment is arranged to be regulated automatically.

Example 15 includes a separator according to any preceding example, further comprising a pressure gauge for sensing the pressure in the first compartment.

Example 16 includes a separator according to any preceding example, further comprising one or more valves for defining the sand and liquid outlet in the lower region of the first compartment.

Example 17 includes a separator according to any of examples 1 to 15, further comprising an auger with its inlet opening into the bottom region of the first compartment and defining the sand and liquid outlet in the lower region of the first compartment.

Example 18 includes a separator according to any preceding example, further comprising a means of separating sand from the sand and liquid mixture discharged from the first compartment.

Example 19 includes a separator according to example 18 when dependent upon example 2, in which the means for separating sand from the sand and liquid mixture comprises a conveyor and the conveyor is incorporated in the same physical unit as the first and second compartments.

Example 20 includes a separator according to any preceding example, further comprising a means for separating organic matter from the organic matter and liquid mixture discharged from the first compartment.

Example 21 includes a separator according to example 18 or 19 when dependent upon example 2, in which the means for separating organic matter from the organic matter and liquid mixture comprises a conveyor screen and the conveyor screen is incorporated in the same physical unit as the first and second compartments.

Example 22 includes a separator according to any preceding example further comprising a pump for recycling liquid recovered from the separator through the liquid inlets in the bottom region of the compartment.

Example 23 includes a method of separating sand from organic matter, the method comprising the following steps: feeding a mixture of sand and organic matter into a first compartment; introducing liquid into a bottom region of the first compartment to generate an upward flow of liquid and create a fluidised bed of sand in the first compartment; removing organic matter and liquid from the top of the mixture in the first compartment; and removing sand and liquid from a lower region of the first compartment.

Example 24 includes a method according to example 23, in which the fluidised bed of sand is created in a lower region only of the first compartment.

Example 25 includes a method according to example 23 or 24, wherein the mixture of sand, organic matter and liquid is fed into a second compartment and passes from there into the first compartment.

Example 26 includes a method according to example 25, in which the mixture of sand, organic matter and liquid is fed into the first compartment at a level below or just above the top of the fluidised bed.

Example 27 includes a method according to example 25 or 26, in which the mixture of sand, organic matter and liquid in the second compartment is agitated to maintain the sand in suspension.

Example 28 includes a method according to any of examples 23 to 27, in which liquid is introduced into the bottom region of the first compartment at a multiplicity of locations spread across the compartment.

Example 29 includes a method according to any of examples 23 to 28, in which organic matter and liquid is removed from the surface of the mixture in the first compartment.

Example 30 includes a method according to example 29, in which the organic matter is removed by scraping.

Example 31 includes a method according to any of examples 23 to 30, in which liquid removed from the first compartment is introduced back into the bottom region of the first compartment.

Example 32 includes a method according to any of examples 23 to 31, further comprising the step of separating sand from the sand and liquid mixture discharged from the first compartment.

Example 33 includes a method according to any of examples 23 to 32, further comprising the step of separating organic matter from the organic matter and liquid mixture discharged from the first compartment.

1. A separator for separating sand from organic matter, the separator comprising:
a first compartment for receiving and separating a mixture of sand, organic matter and liquid,
a plurality of liquid inlets in a bottom region of the first compartment for introducing liquid into the bottom region of the first compartment and generating an upward liquid flow in the first compartment,
means for removing organic matter from the top of the mixture in the first compartment,
an outlet in an upper region of the first compartment for discharge of organic matter and liquid, and
an outlet in a lower region of the first compartment for discharge of sand and liquid.

2. A separator according to claim 1, in which a compartment is a first compartment within a tank that comprises the first compartment and a second compartment from which the mixture is arranged to be fed into the first compartment.

3. A separator according to claim 2, wherein the tank is cuboidal in shape and the first compartment is separated from the second compartment by a partition that extends across the entire width of the tank, perpendicular to adjoining walls of the tank.

4. A separator according to claim 2, in which a mixer is provided in the second compartment.

5. A separator according to claim 1, in which the plurality of liquid inlets are spread across substantially all of the bottom region of the first compartment.

6. (canceled)

7. A separator according to claim 1, in which the plurality of liquid inlets are provided in a bottom of the first compartment and in which the bottom of the first compartment comprises a false floor within a tank.

8. (canceled)

9. A separator according to claim 1, in which the means for removing organic matter from the top of the mixture in the first compartment comprises one or more paddles mounted for movement across an upper region of the first compartment.

10. A separator according to claim 9, in which said one or more paddles are mounted for movement around an endless path.

11. (canceled)

12. A separator according to claim 9, in which each paddle of said one or more paddles extends across the upper region of the first compartment from one side to an other and is mounted for movement along the first compartment in a direction transverse to a direction in which the paddle extends.

13. A separator according to claim 9, in which the one or more paddles are mounted on a shaft for rotation about a fixed axis.

14. A separator according to claim 1, in which removal of sand from the first compartment is arranged to be regulated automatically.

15. A separator according to claim 1, further comprising a pressure gauge for sensing the pressure in the first compartment.

16. A separator according to claim 1, further comprising one or more valves for defining the sand and liquid outlet in the lower region of the first compartment.

17. A separator according to claim 1, further comprising an auger with its inlet opening into the bottom region of the first compartment and defining the sand and liquid outlet in the lower region of the first compartment.

18. (canceled)

19. A separator according to claim 2, comprising a conveyor for separating sand from the sand and liquid mixture discharged from the first compartment, wherein the conveyor is incorporated in to a same physical unit as the first and second compartments.

20. (canceled)

21. A separator according to claim 2 comprising a conveyor screen for separating organic matter from the organic matter and liquid mixture discharged from the first compartment, wherein the conveyor screen is incorporated in to a same physical unit as the first and second compartments.

22. A separator according to claim 1 further comprising a pump for recycling liquid recovered from the separator through the plurality of liquid inlets in the bottom region of the first compartment.

23. A method of separating sand from organic matter, the method comprising the following steps:
feeding a mixture of sand and organic matter into a first compartment;
introducing liquid into a bottom region of the first compartment to generate an upward flow of liquid and create a fluidized bed of sand in the first compartment;
removing organic matter and liquid from the top of the mixture in the first compartment; and
removing sand and liquid from a lower region of the first compartment.

24. A method according to claim 23, in which the fluidized bed of sand is created in a lower region only of the first compartment.

25. A method according to claim 23, wherein the method comprises one or more of the following steps:
the mixture of sand, organic matter and liquid is fed into a second compartment and passes from there into the first compartment;
the mixture of sand, organic matter and liquid is fed into the first compartment at a level below or just above the top of the fluidized bed;
the mixture of sand, organic matter and liquid in the second compartment is agitated to maintain the sand in suspension;
liquid is introduced into the bottom region of the first compartment at a multiplicity of locations spread across the first compartment;
organic matter and liquid is removed from the surface of the mixture in the first compartment;
liquid removed from the first compartment is introduced back into the bottom region of the first compartment;
the step of separating sand from the sand and liquid mixture discharged from the first compartment; and
the step of separating organic matter from the organic matter and liquid mixture discharged from the first compartment.

26-33. (canceled)
